(19) United States
(12) Patent Application Publication
(10) Pub. No.: US 2013/0302619 A1
(43) Pub. Date: Nov. 14, 2013

(54) SUBSTRATE MANUFACTURING METHOD AND MULTI-LAYER STRUCTURE

(71) Applicant: AU OPTRONICS CORPORATION, Hsin-Chu (TW)

(72) Inventors: Min-Chih WEI, HSIN-CHU (TW); Hsiang-Yun WANG, HSIN-CHU (TW); Tai-Hsiang HUANG, HSIN-CHU (TW)

(73) Assignee: AU OPTRONICS CORPORATION, HSIN-CHU (TW)

(21) Appl. No.: 13/792,378

(22) Filed: Mar. 11, 2013

(30) Foreign Application Priority Data
May 11, 2012 (TW) 101116887

(51) Int. Cl. B32B 37/14; B32B 7/12

(52) U.S. Cl. CPC B32B 37/144; B32B 7/12
USPC 428/411.1; 156/275.5

(57) ABSTRACT

A substrate manufacturing method includes steps of: providing a transparent substrate; applying an adhesive layer to a surface of the transparent substrate; disposing a flexible substrate on the adhesive layer to form a multi-layer structure; disposing the multi-layer structure over the reflector, in which the reflector has a first reflecting region and a second reflecting region, and the reflectivity of the first reflecting region is greater than the reflectivity of the second reflecting region; and hardening the adhesive layer by performing an ultraviolet radiation toward the multi-layer structure to form a first hardened portion and a second hardened portion.

### RELATED APPLICATIONS

This application claims priority to Taiwan Application Serial Number 101116887, filed May 11, 2012, which is herein incorporated by reference.

### BACKGROUND

1. Technical Field

The present disclosure relates to a substrate manufacturing method, and more particularly, to a processing method of a flexible display.

2. Description of Related Art

The display device market has been rapidly changing, and flat panel display (FPD) now has become the main stream in the market. The FPD devices can be easily made in a large but thin dimension with lightweight. The FPD devices include liquid crystal displays (LCDs), plasma display panels (PDPs), organic electro luminescence displays (OLEDs), etc. However, the existing liquid crystal displays, plasma display panels, organic electro luminescence displays, etc. are all made of a glass substrate, thereby limiting application and usage thereof due to without flexibility.

Currently, a flexible display device has been fabricated using a substrate of a material having flexibility, such as plastic or foil, which is a promising replacement for the existing glass substrate with no flexibility. The flexible display device is normally called a “bendable display” or “rollable display,” and can be used in a LCD, an OLED, an electrophoretic display (EPD), etc.

During manufacturing processes of the flexible display, a flexible substrate is adhered to a hard substrate before performing process steps of making display parts. The flexible substrate is de-bonded from the hard substrate at end of the manufacturing processes. If the adhesion between the flexible substrate and the hard substrate is too strong, the display parts will be damaged during the process of de-bonding; and if adhesion between the flexible substrate and the hard substrate is too weak, the de-boding between the flexible substrate and the hard substrate will occurred during the manufacturing processes of the display parts. Accordingly, many in the industry are endeavoring to develop techniques of improving the process yield rate of the flexible display.

To solve the foregoing problem, two approaches have been used. The first approach is adhering the flexible substrate and the hard substrate by using adhesive materials having different adhesion formed by multiple adhesive layers. The second approach is adhering the flexible substrate and the hard substrate by using adhesive materials having different adhesion formed by a single adhesive layer.

However, for the first approach, with the increase of types and total thickness of the multiple adhesive layers, the problem of thermal bending is getting serious after high-temperature processes. For the second approach, coefficients of thermal expansion (CTE) of the different adhesive materials must be similar. Moreover, the different adhesive materials diffuse with each other and thus are hard to be controlled during adhering, thereby increasing the complexity of a glue coating process.

### SUMMARY

In order to solve the problems of the prior art, the disclosure provides an improved substrate manufacturing method, in which a transparent substrate and a flexible substrate are adhered to each other by using a single adhesive layer that only has a single material. The adhesive layer between the transparent substrate and the flexible substrate has local differences after processes of the disclosure and thus has at least two kinds of adhesion. The disclosure uses the single adhesive layer, so the problem of thermal bending can be eased. The transparent substrate and the flexible substrate are adhered to each other by the adhesive layer only having the single material, so the process of glue coating can be easily realized, and the mechanism of the used adhering machine can be simple. Furthermore, the processes provided in the disclosure not only can precisely control locations of adhesive portions having different adhesion of the adhesive layer, but also can form the adhesive layer into complicated adhesive patterns. Therefore, the stability and difficulty during the final manufacturing step of the flexible display (i.e., the de-bonding process of the transparent substrate relative to the flexible substrate) can be effectively improved.

According to an embodiment of the disclosure, a substrate manufacturing method includes the steps of: providing a transparent substrate, in which the transparent substrate includes a first surface and a second surface opposite to each other; applying an adhesive layer to the first surface of the transparent substrate; disposing a flexible substrate on the adhesive layer to form a multi-layer structure; disposing the multi-layer structure over a reflector, in which the reflector has a first reflecting region and a second reflecting region, and the reflectivity of the first reflecting region is greater than the reflectivity of the second reflecting region; and hardening the adhesive layer by performing an ultraviolet radiation toward the multi-layer structure to form a first hardened portion and a second hardened portion respectively corresponding to the first reflecting region and the second reflecting region, in which the adhesion between the first hardened portion and the flexible substrate is different from the adhesion between the second hardened portion and the flexible substrate.

In an embodiment of the disclosure, the reflector is disposed at a side of the flexible substrate that is away from the adhesive layer.

In an embodiment of the disclosure, the reflector is disposed on the second surface of the transparent substrate.

In an embodiment of the disclosure, the second reflecting region surrounds the periphery of the first reflecting region.

In an embodiment of the disclosure, the adhesion between the second hardened portion and the flexible substrate is essentially greater than the adhesion between the first hardened portion and the flexible substrate.

In an embodiment of the disclosure, the adhesive layer is an ultraviolet curable adhesive layer.

In an embodiment of the disclosure, the adhesive layer is a non-thermoplastic adhesive layer.

According to another embodiment of the disclosure, a substrate manufacturing method includes the steps of: providing a transparent substrate; applying an adhesive layer to the transparent substrate; disposing a flexible substrate on the adhesive layer to form a multi-layer structure; disposing a filter separately over the multi-layer structure; and hardening the adhesive layer by performing an ultraviolet radiation toward the multi-layer structure from a side of the filter that is away from the multi-layer structure to form a first hardened portion and a second hardened portion respectively by a portion of the ultraviolet radiation that passes through the filter and another portion of the ultraviolet radiation that does not pass through the filter.

In an embodiment of the disclosure, the transparent substrate is located between the filter and the flexible substrate.

In an embodiment of the disclosure, the flexible substrate is located between the filter and the transparent substrate.

In an embodiment of the disclosure, the filter is an ultraviolet filter for absorbing a specific band of the ultraviolet radiation.

According to another embodiment of the disclosure, a multi-layer structure includes a transparent substrate, an adhesive layer, and a flexible substrate. The adhesive layer is disposed on the transparent substrate and has a first region and a second region that surrounds the first region. The flexible substrate is disposed on the adhesive layer. The adhesive layer is made of an ultraviolet curable adhesive layer after irradiated by an ultraviolet radiation. The adhesion between the flexible substrate and the portion of the adhesive layer in the first region is less than the adhesion between the flexible substrate and the portion of the adhesive layer in the second hardened portion.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows:

FIG. 1A is a perspective view of a multi-layer structure and a reflector according to an embodiment of the disclosure;

FIG. 1B is a partially cross-sectional view of the multi-layer structure and the reflector along line 1B-1B′;

FIG. 2 is a flow chart of a substrate manufacturing method according to an embodiment of the disclosure;

FIG. 3 is a 180 degrees tensile test chart of an adhesive layer relative to a flexible substrate in FIG. 1B;

FIG. 4 is a partially cross-sectional view of a multi-layer structure and a reflector according to another embodiment of the disclosure;

FIG. 5A is a perspective view of a multi-layer structure and a filter according to another embodiment of the disclosure;

FIG. 5B is a partially cross-sectional view of the multi-layer structure and the filter along line 5B-5B′;

FIG. 6 is a flow chart of a substrate manufacturing method according to another embodiment of the disclosure;

FIG. 7 is a 180 degrees tensile test chart of an adhesive layer relative to a flexible substrate in FIG. 5B; and

FIG. 8 is a partially cross-sectional view of the multi-layer structure and the filter according to another embodiment of the disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

An improved substrate manufacturing method is provided. Specifically, a transparent substrate and a flexible substrate are adhered to each other by using a single adhesive layer that only has a single material. The adhesive layer between the transparent substrate and the flexible substrate has local differences after processes of the disclosure and thus has at least two kinds of adhesion. The disclosure uses the single adhesive layer, so the problem of thermal bending can be eased. The transparent substrate and the flexible substrate are adhered to each other by the adhesive layer only having the single material, so the process of glue coating can be easily realized, and the mechanism of the used adhering machine can be simple. Furthermore, the processes provided in the disclosure not only can precisely control locations of adhesive portions having different adhesion of the adhesive layer, but also can form the adhesive layer into complicated adhesive patterns.

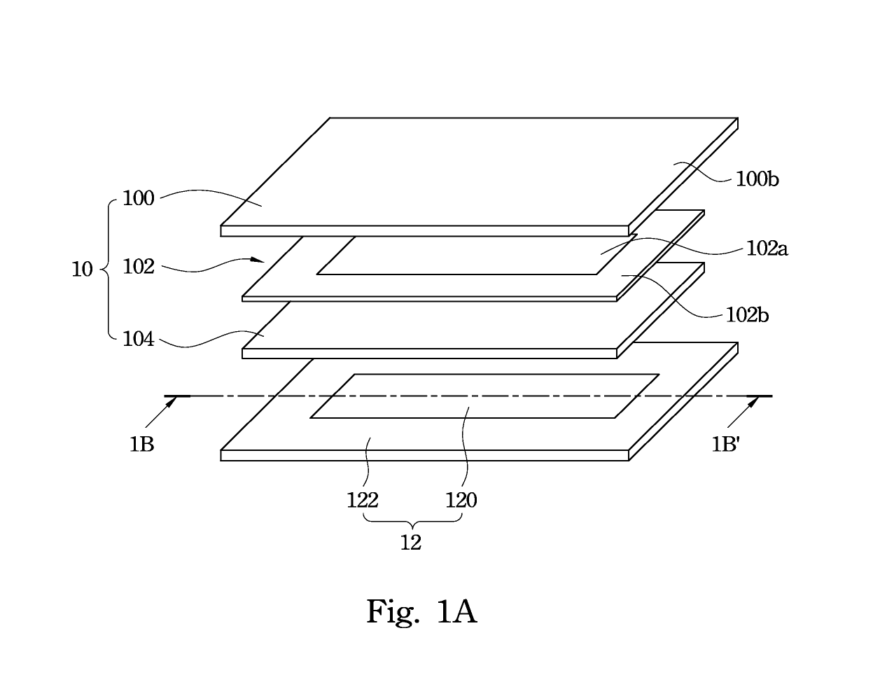

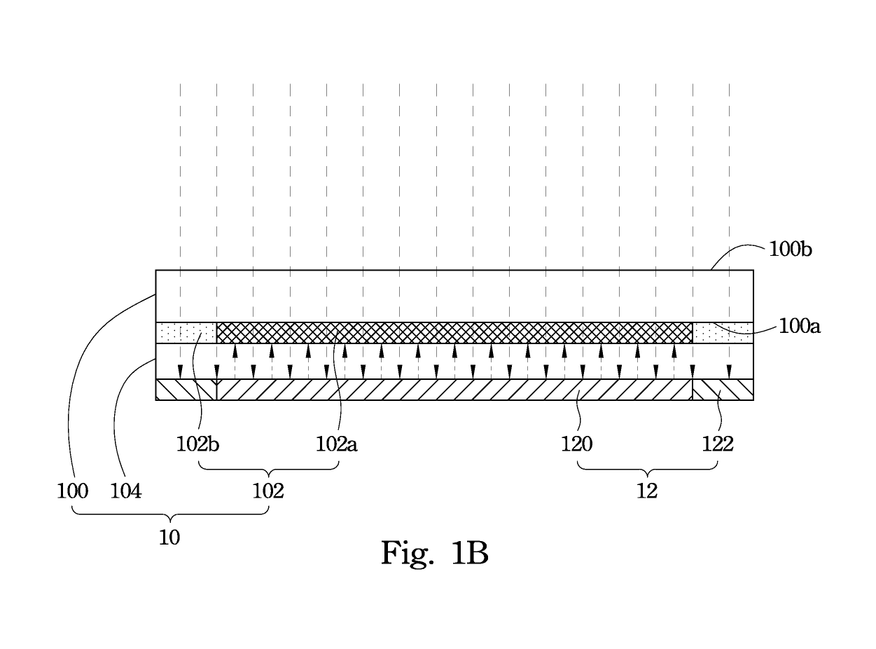

FIG. 1A is a perspective view of a multi-layer structure 10 and a reflector 12 according to an embodiment of the disclosure. FIG. 1B is a partially cross-sectional view of the multi-layer structure 10 and the reflector 12 along line 1B-1B′. The multi-layer structure 10 includes a transparent substrate 100, an adhesive layer 102, and a flexible substrate 104. In an embodiment of the disclosure, the transparent substrate 100 of the multi-layer structure 10 can be a glass substrate, but the disclosure is not limited in this regard. An opaque hard substrate that can provide enough supporting force to the flexible substrate 104 can be used in the disclosure.

In the embodiment of the disclosure, the adhesive layer 102 of the multi-layer structure 10 is an ultraviolet curable adhesive layer which can absorb the irradiation energy of the ultraviolet radiation to polymerize and thereby hardening.

Furthermore, in order to solve the problem of thermal bending during high-temperature process of the manufacture of a flexible display, the adhesive layer 102 of the multi-layer structure 10 can be a non-thermoplastic adhesive layer, but the disclosure is not limited in this regard.

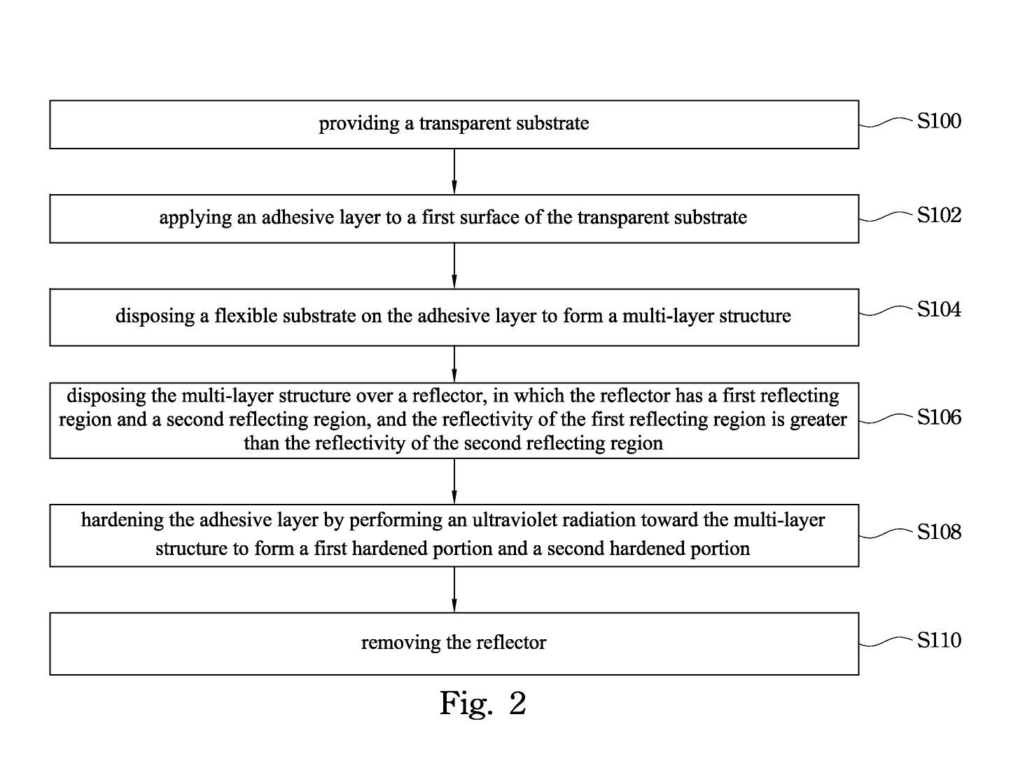

FIG. 2 is a flow chart of a substrate manufacturing method according to an embodiment of the disclosure. As shown in FIG. 1A, FIG. 1B, and FIG. 2, the substrate manufacturing method of the disclosure at least includes Step S100 to Step S110 below.

Step S100: providing a transparent substrate 100. The transparent substrate 100 includes a first surface 100a and a second surface 100b that are opposite to each other (i.e., the upper surface and the lower surface of the transparent substrate 100 in FIG. 1B).

Step S102: applying an adhesive layer 102 to a first surface 100a of the transparent substrate 100.

Step S104: disposing a flexible substrate 104 on the adhesive layer 102 to form a multi-layer structure 10. In other words, the transparent substrate 100, the adhesive layer 102, and the flexible substrate 104 together form the foregoing multi-layer structure 10.

Step S106: disposing the multi-layer structure 10 over a reflector 12, in which the reflector 12 has a first reflecting region 120 and a second reflecting region 122, and the reflectivity of the first reflecting region 120 is greater than the reflectivity of the second reflecting region 122. In the embodiment of the disclosure, the second reflecting region 122 of the reflector 12 essentially surrounds the first reflecting region 120.

Step S108: hardening the adhesive layer 102 by performing an ultraviolet radiation toward the multi-layer structure 10 to form a first hardened portion 102a and a second hardened portion 102b respectively corresponding to the first reflecting region 120 and the second reflecting region 122, in which the adhesion between the first hardened portion 102a and the flexible substrate 104 is different from the adhesion between the second hardened portion 102b and the flexible substrate 104.

Step S110: removing the reflector 12.

As shown in FIG. 1B, the reflector 12 is disposed at a side of the flexible substrate 104 that is away from the adhesive layer 102, and the ultraviolet radiation is performed from the top of the second surface 100b of the transparent substrate 100 (i.e., from the top of the upper surface of the transparent substrate 100 in FIG. 1B).

In FIG. 1B, it can be clearly seen that the ultraviolet radiation is performed right toward the multi-layer structure 10, and the orthographic projections of the first hardened portion 102a and the second hardened portion 102b of the adhesive layer 102 in the multi-layer structure 10 that are projected on the reflector 12 respectively correspond to the first reflecting region 120 and the second reflecting region 122. Therefore, after the ultraviolet radiation subsequently passes through the transparent substrate 100, the adhesive layer 102, and the flexible substrate 104 of the multi-layer structure 10, the first reflecting region 120 that has larger reflectivity reflects more amount of the ultraviolet radiation back to the adhesive layer 102 via the flexible substrate 104, so that per unit area of the first hardened portion 102a of the adhesive layer 102 absorbs excessive amount of the ultraviolet radiation. On the contrary, the second reflecting region 122 that has smaller reflectivity reflects less amount of the ultraviolet radiation back to the adhesive layer 102 via the flexible substrate 104, so that per unit area of the second hardened portion 102b of the adhesive layer 102 does not absorb excessive amount of the ultraviolet radiation. Accordingly, the substrate manufacturing method of the disclosure can make per unit area of the first hardened portion 102a and per unit area of the second hardened portion 102b of the adhesive layer 102 respectively absorb different amount of the ultraviolet radiation, so that different degrees of polymerization will be respectively occurred to the first hardened portion 102a and the second hardened portion 102b of the adhesive layer 102 and thereby resulting in different adhesion.

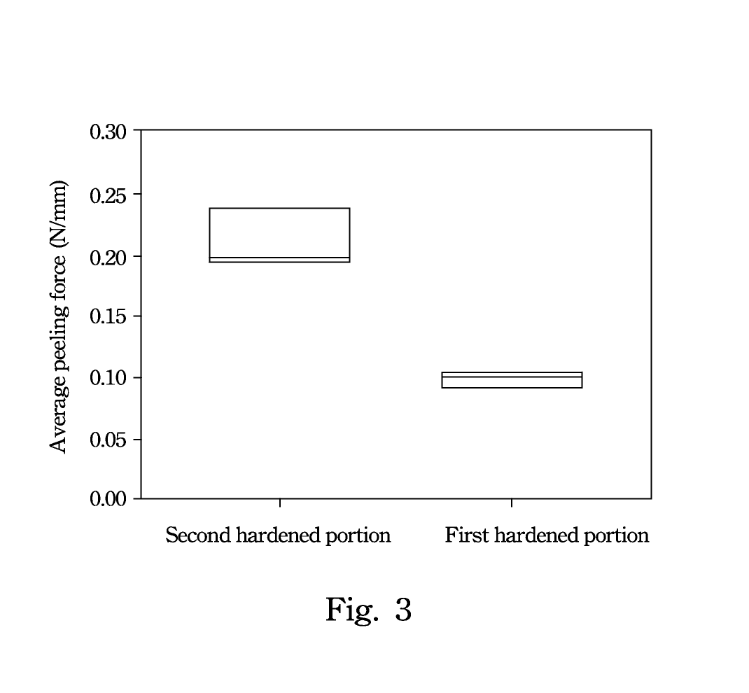

FIG. 3 is a 180 degrees tensile test chart of an adhesive layer 102 relative to a flexible substrate 104 in FIG. 1B.

FIG. 3 is a statistical chart made of average peeling forces at different locations of the adhesive layer 102 in 180 degrees tensile tests of the adhesive layer 102 relative to the flexible substrate 104 after continuously radiating the ultraviolet radiation with 55 mW/cm² irradiation intensity and 180 seconds exposure time to the multi-layer structure 10. In FIG. 3, it can be clearly seen that the average peeling force of the flexible substrate 104 relative to the first hardened portion 102a of the adhesive layer 102 is 0.10 N/mm, and the average peeling force of the flexible substrate 104 relative to the second hardened portion 102b of the adhesive layer 102 is 0.21 N/mm.

In FIG. 3, it can be seen that the adhesion between the first hardened portion 102a and the flexible substrate 104 is smaller. Because per unit area of the first hardened portion 102a of the adhesive layer 102 absorbs excessive amount of the ultraviolet radiation, molecular chains are increased and thus result in that the polymerization is incomplete, so that the adhesion between the first hardened portion 102a and the flexible substrate 104 decays. On the contrary, because per unit area of the second hardened portion 102b of the adhesive layer 102 does not absorb excessive amount of the ultraviolet radiation, the polymerization is more complete, so that the adhesion between the second hardened portion 102b and the flexible substrate 104 is greater. Accordingly, the adhesion between the second hardened portion 102b and the flexible substrate 104 is essentially greater than the adhesion between the first hardened portion 102a and the flexible substrate 104.

In other words, in the substrate manufacturing method of the disclosure, the patterns and relative positions of the first reflecting region 120 and the second reflecting region 122 of the reflector 12 can be adjusted according to requirements, so that the purpose of obtaining a weaker peeling force at the portion of the flexible substrate 104 corresponding to the first reflecting region 120 and a stronger peeling force at the portion of the flexible substrate 104 corresponding to the second reflecting region 122 can be achieved.

During the manufacture of a flexible display, the display part of the flexible display is generally disposed at the center region of the flexible substrate 104. Therefore, the peeling force at the center region of the flexible substrate 104 is undesired to be too large, which may result in damaging the display part, during the de-bonding process of the transparent substrate 100 relative to the flexible substrate 104. In order to solve the problem, the second reflecting region 122 of the reflector 12 is designed to surround the periphery of the first reflecting region 120, as shown in FIG. 1A. Correspondingly, the second hardened portion 102b that corresponds to the second reflecting region 122 also surrounds the periphery of the first hardened portion 102a that corresponds to the first reflecting region 120. After directly cutting off the region of the multi-layer structure 10 corresponding to the second hardened portion 102b that is located at the periphery, the remained flexible substrate 104 corresponding to the display part of the flexible display can be easily separated apart from the first hardened portion 102a that is located at the center region, thereby reducing the probability of damage occurred to the display part of the flexible display located at the center region of the flexible substrate 104.

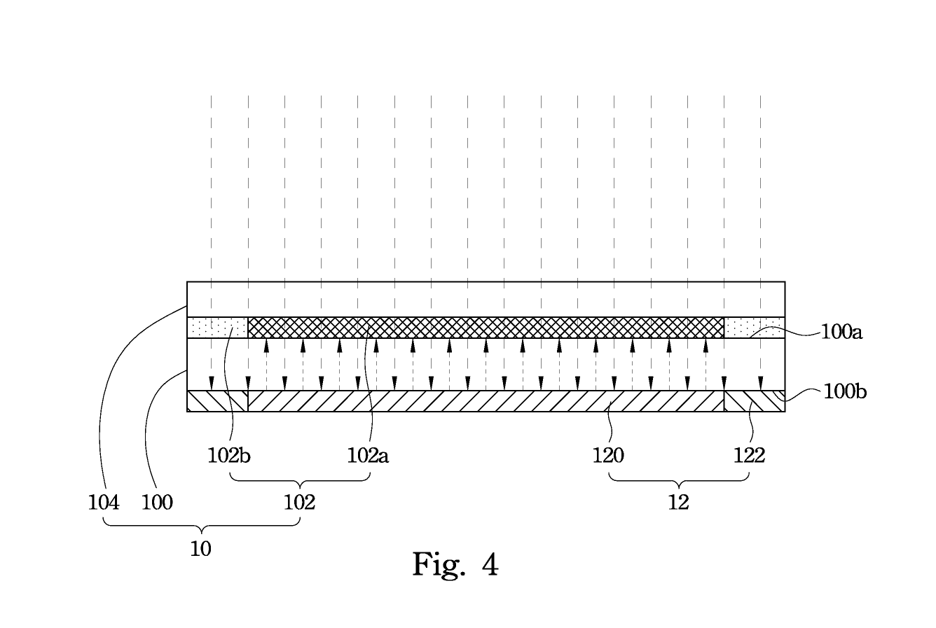

FIG. 4 is a partially cross-sectional view of a multi-layer structure 10 and a reflector 12 according to another embodiment of the disclosure.

As shown in FIG. 4, compared with the embodiment in FIG. 1B, the reflector 12 of the present embodiment is disposed on the second surface 100b of the transparent substrate 100 (i.e., the lower surface of the transparent substrate 100 in FIG. 4), and the ultraviolet radiation is performed from a side of the flexible substrate 104 that is away from the adhesive layer 102. Therefore, after the ultraviolet radiation subsequently passes through the flexible substrate 104, the adhesive layer 102, and the transparent substrate 100 of the multi-layer structure 10, the first reflecting region 120 that has larger reflectivity reflects more amount of the ultraviolet radiation back to the adhesive layer 102 via the transparent substrate 100, so that per unit area of the first hardened portion 102a of the adhesive layer 102 absorbs excessive amount of the ultraviolet radiation. On the contrary, the second reflecting region 122 that has smaller reflectivity reflects less amount of the ultraviolet radiation back to the adhesive layer 102 via the transparent substrate 100, so that per unit area of the second hardened portion 102b of the adhesive layer 102 does not absorb excessive amount of the ultraviolet radiation. Accordingly, the substrate manufacturing method of the disclosure can make per unit area of the first hardened portion 102a and per unit area of the second hardened portion 102b of the adhesive layer 102 respectively absorb different amount of the ultraviolet radiation, so that different degrees of polymerization will be respectively occurred to the first hardened portion 102a and the second hardened portion 102b of the adhesive layer 102 and thereby resulting in different adhesion.

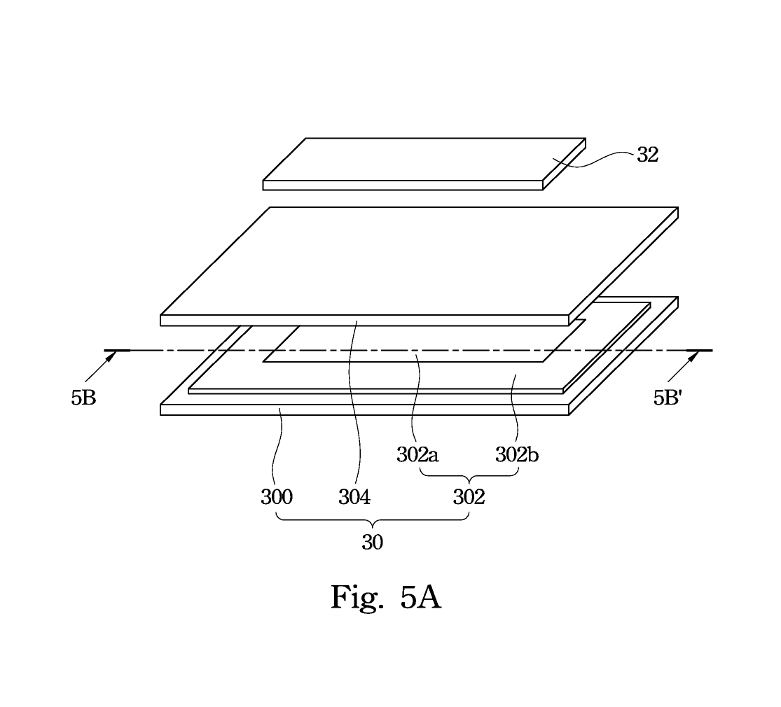

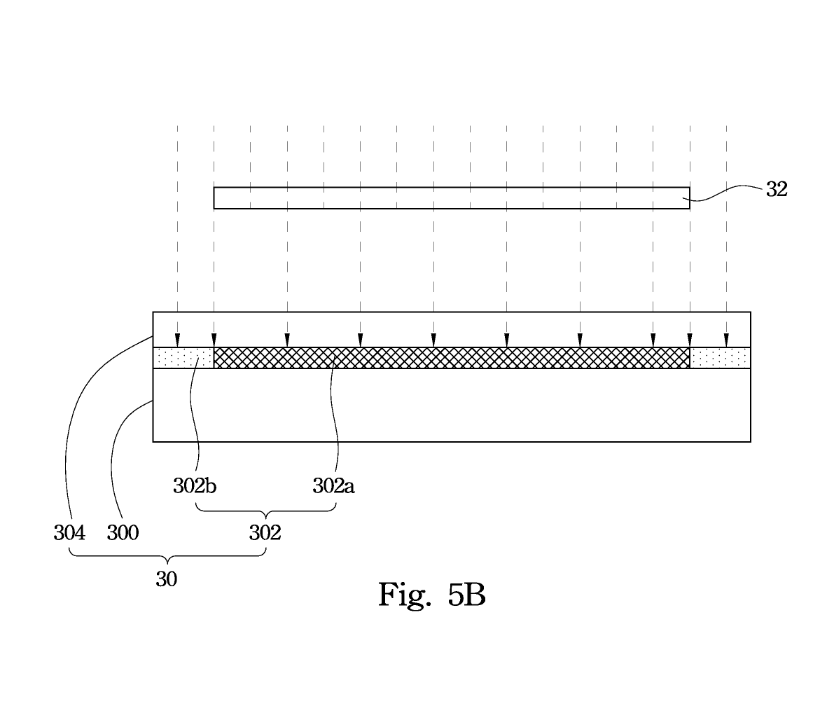

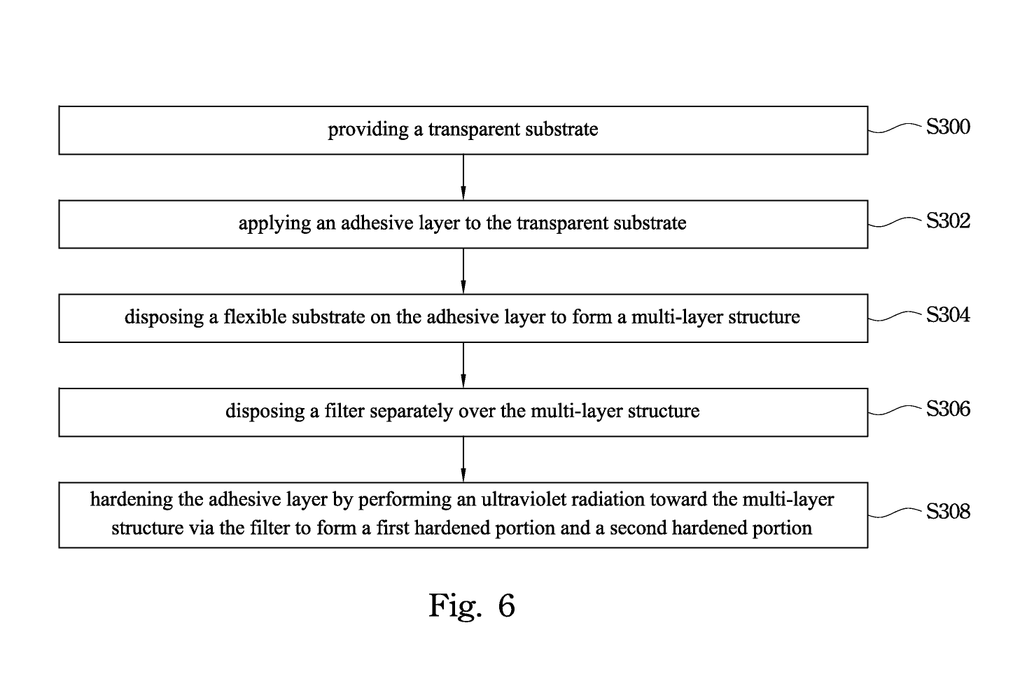

FIG. 5A is a perspective view of a multi-layer structure 30 and a filter 32 according to another embodiment of the disclosure. FIG. 5B is a partially cross-sectional view of the multi-layer structure 30 and the filter 32 along line 5B-5B′. The multi-layer structure 30 includes a transparent substrate 300, an adhesive layer 302, and a flexible substrate 304. FIG. 6 is a flow chart of a substrate manufacturing method according to another embodiment of the disclosure.

As shown in FIG. 5A, FIG. 5B, and FIG. 6, the substrate manufacturing method of the disclosure at least includes the steps of Step S300 to Step S308 below.

Step S300: providing a transparent substrate 300.

Step S302: applying an adhesive layer 302 to the transparent substrate 300.

Step S304: disposing a flexible substrate 304 on the adhesive layer 302 to form a multi-layer structure 30. In other words, the transparent substrate 300, the adhesive layer 302, and the flexible substrate 304 together form the foregoing multi-layer structure 30.

Step S306: disposing a filter 32 separately over the multi-layer structure 30.

As shown in FIG. 5B, the filter 32 is separately disposed at a side of the flexible substrate 304 that is away from the adhesive layer 302 (i.e., the upper side of the flexible substrate 304 in FIG. 5B). Therefore, the flexible substrate 304 is located between the filter 32 and the transparent substrate 300.

Step S308: hardening the adhesive layer 302 by performing an ultraviolet radiation toward the multi-layer structure 30 via the filter 32 to form a first hardened portion 302a and a second hardened portion 302b respectively irradiated by a portion of the ultraviolet radiation that passes through the filter 32 and another portion of the ultraviolet radiation that does not pass through the filter 32.

In the embodiment of the disclosure, the filter 32 is an ultraviolet filter for absorbing a specific band of the ultraviolet radiation.

In FIG. 5B, it can be clearly seen that the ultraviolet radiation is performed right toward the multi-layer structure 30 at the side of the filter 32 that is away from the multi-layer structure 30 (i.e., the radiating direction of the ultraviolet radiation is perpendicular to the multi-layer structure 30), and the orthographic projection of the filter 32 projected on the adhesive layer 302 corresponds to the first hardened portion 302a. Therefore, the portion of the ultraviolet radiation that passes through the filter 32 and of which a specific band is absorbed by the filter 32 is then absorbed by the first hardened portion 302a of the adhesive layer 302 after passing through the flexible substrate 304 of the multi-layer structure 30. On the contrary, the portion of the ultraviolet radiation that does not pass through the filter 32 is absorbed by the second hardened portion 302b of the adhesive layer 302 after passing through the flexible substrate 304 of the multi-layer structure 30. Accordingly, the substrate manufacturing method of the disclosure can make per unit area of the first hardened portion 302a and per unit area of the second hardened portion 302b of the adhesive layer 302 respectively absorb different bands of the ultraviolet radiation, so that different degrees of polymerization will be respectively occurred to the first hardened portion 302a and the second hardened portion 302b of the adhesive layer 302 and thereby resulting in different adhesion.

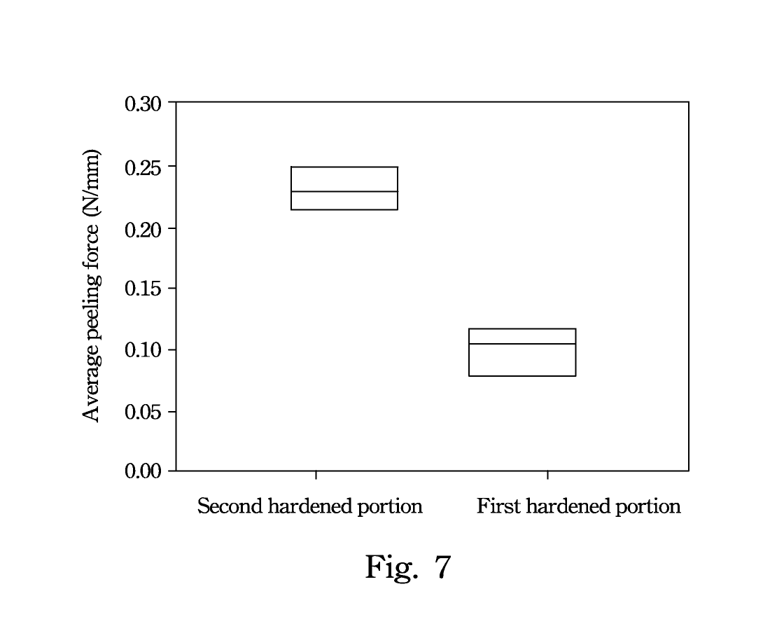

FIG. 7 is a 180 degrees tensile test chart of an adhesive layer 302 relative to a flexible substrate 304 in FIG. 5B.

FIG. 7 is a statistical chart made of average peeling forces at different locations of the adhesive layer 302 in 180 degrees tensile tests of the adhesive layer 302 relative to the flexible substrate 304 after continuously radiating the ultraviolet radiation with 20000 mJ UV dosage to the multi-layer structure 30. In FIG. 7, it can be clearly seen that the average peeling force of the flexible substrate 304 relative to the first hardened portion 302a of the adhesive layer 302 is 0.098 N/mm, and the average peeling force of the flexible substrate 304 relative to the second hardened portion 302b of the adhesive layer 302 is 0.228 N/mm.

In FIG. 7, it can be seen that the adhesion between the first hardened portion 302a and the flexible substrate 304 is smaller. After passing through the filter 32, a specific band of the ultraviolet radiation is absorbed by the filter 32. Therefore, compared with the second hardened portion 302b, the first hardened portion 302a does not absorb enough ultraviolet irradiation energy, so that the polymerization of the first hardened portion 302a is incomplete and thus the adhesion between the first hardened portion 302a and the flexible substrate 304 decays. On the contrary, the filter 32 is not disposed above the second hardened portion 302b. Therefore, compared with the first hardened portion 302a, the second hardened portion 302b absorbs enough ultraviolet irradiation energy, so that the polymerization of the second hardened portion 302b is more complete and thus the adhesion between the second hardened portion 302b and the flexible substrate 304 is greater. In other words, the first hardened portion 302a and the second hardened portion 302b respectively absorb different bands of the ultraviolet irradiation energy, so that different degrees of polymerization will be respectively occurred to the first hardened portion 302a and the second hardened portion 302b of the adhesive layer 302 and thereby resulting in different adhesion. Accordingly, the adhesion between the second hardened portion 302b and the flexible substrate 304 is essentially greater than the adhesion between the first hardened portion 302a and the flexible substrate 304.

In other words, in the substrate manufacturing method of the disclosure, the pattern and relative position of the filter 32 can be adjusted according to requirements, so that the purpose of obtaining a weaker peeling force at the portion of the flexible substrate 304 corresponding to the filter 32 and a stronger peeling force at the portion of the flexible substrate 304 not corresponding to the filter 32 can be achieved.

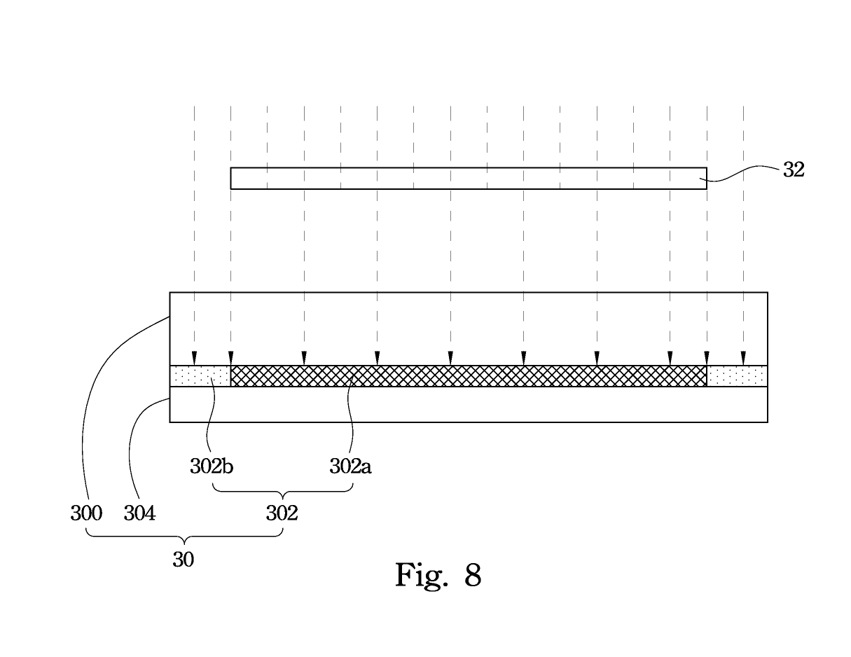

FIG. 8 is a partially cross-sectional view of the multi-layer structure 30 and the filter 32 according to another embodiment of the disclosure.

As shown in FIG. 8, compared with the embodiment in FIG. 5B, the filter 32 of the present embodiment is disposed at a side of the transparent substrate 300 that is away from the adhesive layer 302 (i.e., the upper side of the transparent substrate 300 in FIG. 3), and the transparent substrate 300 is located between the filter 32 and the flexible substrate 304. Therefore, the portion of the ultraviolet radiation that passes through the filter 32 and of which a specific band is absorbed by the filter 32 is then absorbed by the first hardened portion 302a of the adhesive layer 302 after passing through the transparent substrate 300 of the multi-layer structure 30. On the contrary, the portion of the ultraviolet radiation that does not pass through the filter 32 is absorbed by the second hardened portion 302b of the adhesive layer 302 after passing through the transparent substrate 300 of the multi-layer structure 30. Accordingly, the substrate manufacturing method of the disclosure can make per unit area of the first hardened portion 302a and per unit area of the second hardened portion 302b of the adhesive layer 302 respectively absorb different bands of the ultraviolet irradiation energy, so that different degrees of polymerization will be respectively occurred to the first hardened portion 302a and the second hardened portion 302b of the adhesive layer 302 and thereby resulting in different adhesion.

According to the foregoing recitations of the embodiments of the disclosure, it can be seen that in the substrate manufacturing method of the disclosure, a transparent substrate and a flexible substrate are adhered to each other by using a single adhesive layer that only has a single material. The adhesive layer between the transparent substrate and the flexible substrate has local differences after processes of the disclosure and thus has at least two kinds of adhesion. The disclosure uses the single adhesive layer, so the problem of thermal bending can be eased. The transparent substrate and the flexible substrate are adhered to each other by the adhesive layer only having the single material, so the process of glue coating can be easily realized, and the mechanism of the used adhering machine can be simple. Furthermore, the processes provided in the disclosure not only can precisely control locations of adhesive portions having different adhesion of the adhesive layer, but also can form the adhesive layer into complicated adhesive patterns. Therefore, the stability and difficulty during the final manufacturing step of the flexible display (i.e., the de-bonding process of the transparent substrate relative to the flexible substrate) can be effectively improved.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A substrate manufacturing method comprising:
providing a transparent substrate, wherein the transparent substrate comprises a first surface and a second surface opposite to each other;
applying an adhesive layer to the first surface of the transparent substrate;
disposing a flexible substrate on the adhesive layer to form a multi-layer structure;
disposing the multi-layer structure over a reflector, wherein the reflector has a first reflecting region and a second reflecting region, and the reflectivity of the first reflecting region is greater than the reflectivity of the second reflecting region; and
hardening the adhesive layer by performing an ultraviolet radiation toward the multi-layer structure to form a first hardened portion and a second hardened portion respectively corresponding to the first reflecting region and the second reflecting region, wherein the adhesion between the first hardened portion and the flexible substrate is different from the adhesion between the second hardened portion and the flexible substrate.

2. The substrate manufacturing method of claim 1, wherein the reflector is disposed at a side of the flexible substrate that is away from the adhesive layer.

3. The substrate manufacturing method of claim 1, wherein the reflector is disposed on the second surface of the transparent substrate.

4. The substrate manufacturing method of claim 1, wherein the second reflecting region surrounds the periphery of the first reflecting region.

5. The substrate manufacturing method of claim 1, wherein the adhesion between the second hardened portion and the flexible substrate is essentially greater than the adhesion between the first hardened portion and the flexible substrate.

6. The substrate manufacturing method of claim 1, wherein the adhesive layer is an ultraviolet curable adhesive layer.

7. The substrate manufacturing method of claim 1, wherein the adhesive layer is a non-thermoplastic adhesive layer.

8. A substrate manufacturing method comprising:
providing a transparent substrate;
applying an adhesive layer to the transparent substrate;
disposing a flexible substrate on the adhesive layer to form a multi-layer structure;
disposing a filter separately over the multi-layer structure; and
hardening the adhesive layer by performing an ultraviolet radiation toward the multi-layer structure via the filter to form a first hardened portion and a second hardened portion respectively irradiated by a portion of the ultraviolet radiation that passes through the filter and another portion of the ultraviolet radiation that does not pass through the filter.

9. The substrate manufacturing method of claim 8, wherein the transparent substrate is located between the filter and the flexible substrate.

10. The substrate manufacturing method of claim 8, wherein the flexible substrate is located between the filter and the transparent substrate.

11. The substrate manufacturing method of claim 8, the adhesion between the second hardened portion and the flexible substrate is essentially greater than the adhesion between the first hardened portion and the flexible substrate.

12. The substrate manufacturing method of claim 8, wherein the filter is an ultraviolet filter for absorbing a specific band of the ultraviolet radiation.

13. The substrate manufacturing method of claim 8, wherein the adhesive layer is an ultraviolet curable adhesive layer.

14. The substrate manufacturing method of claim 8, wherein the adhesive layer is a non-thermoplastic adhesive layer.

15. A multi-layer structure comprising:
a transparent substrate;
an adhesive layer disposed on the transparent substrate and having a first region and a second region that surrounds the first region; and
a flexible substrate disposed on the adhesive layer,
wherein the adhesive layer is made of an ultraviolet curable adhesive layer after irradiated by an ultraviolet radiation, and the adhesion between the flexible substrate and the portion of the adhesive layer in the first region is less than the adhesion between the flexible substrate and the portion of the adhesive layer in the second hardened portion.
